(19) United States
(12) Patent Application Publication
(10) Pub. No.: US 2011/0107800 A1
(43) Pub. Date: May 12, 2011

(54) LATCH SYSTEM AND A VEHICLE

(76) Inventors: Stephane Barbier, Saint-Jean-Kerdaniel (FR); Dominique Benoit, Bart (FR); Remi Castella, Andelu (FR)

(21) Appl. No.: 12/889,834

(22) Filed: Sep. 24, 2010

(30) Foreign Application Priority Data
Oct. 27, 2009 (GB) 0918810.3

(51) Int. Cl. E05B 47/00; E05C 21/00; E05B 19/00; E05B 65/12; E05B 65/06

(52) U.S. Cl. 70/101; 70/266; 70/393; 70/280; 70/237

(57) ABSTRACT

A latch system includes a latch and a key barrel operably coupled via a clutch to the latch. The clutch has an engaged condition where operation of the key barrel unlatches the latch, and the clutch has a disengaged condition where operation of the key barrel does not unlatch the latch.

### REFERENCE TO RELATED APPLICATION

This application claims priority to United Kingdom Application No. GB 0918810.3 filed Oct. 27, 2010.

### BACKGROUND OF THE INVENTION

The present invention relates to a latch system, in particular a latch system for use on a vehicle. The present invention also relates to a vehicle, especially a land vehicle, such as a truck or a car.

Cars are known whereby passenger doors can be opened to allow ingress and egress of passengers (which term includes a driver of the vehicle). The doors can also be closed to ensure the passengers within the vehicle do not fall out of the vehicle. The latch can have differing security states, for example, the latch can be unlocked where operation of an outside door handle or an inside door handle will release the latch. The latch can be superlocked, where operation of an outside door handle or operation of an inside door handle will not release the latch. The latch may have a child safety on feature where operation of the inside handle will not release the latch. The latch may be locked, and assuming any child safety feature is off, the latch cannot be opened from the outside but can be opened from the inside. Alternatively, if a child safety feature is on and the latch is locked, a single pull of the outside door handle will not release the latch, and a single pull of the inside door handle will not release the latch.

In order to lock or unlock a latch, a key barrel can be provided on the outside of the door which is operated by a key. Turning the key barrel by the key in one direction will lock the latch, and turning the key barrel by the key in an opposite direction will unlock the latch. With the latch in an unlocked condition, operation of a separate and distinct outside door handle lever will cause the latch to be unlatched and hence allow the door to be opened. Note that operation of the key barrel via the key does not open the latch, it merely unlocks the latch.

Such latches may also be locked and unlocked remotely. A signal (typically a coded radio signal) can be sent from a remote hand held transmitter (typically incorporated into the vehicle door key), which is received by a sensor in the vehicle which in turn controls an electric actuator which operates to lock or unlock the latch.

In an alternative system, as described in GB2424445, a key cylinder is operated by a key to release the latch. Such a system is particularly suited to a vehicle boot lid and is aimed at preventing the keys being locked in the boot by inadvertently closing the boot lid. In this case, the key barrel is permanently connected to a pawl of the latch and hence turning of the key in an unlatching direction will always unlatch the latch.

It is known to use electric actuators to release a latch (as opposed to unlocking the latch). The advantage of using an electric motor to release the latch is that the security status of a latch can be defined by software within the control system. However, should the power source (typically a battery) fail, then there is no way of releasing the latch and hence no way of opening the door. For this reason, car manufacturers have always provided a manual backup way of opening the door from the outside, typically a door handle. The problem with providing a door handle on the outside of the vehicle is that the design freedom of the vehicle in the region of the door handle is limited.

### SUMMARY OF THE INVENTION

Thus, an object of the present invention is to provide a system for releasing a latch from the outside wherein design freedom is less limited.

Thus, according to the present invention, there is provided a latch system including a latch, a key barrel operably coupled via a clutch to the latch, the clutch having an engaged condition where operation of the key barrel unlatches the latch, and the clutch having a disengaged condition where operation of the key barrel does not unlatch the latch.

Advantageously, when the key barrel is operated, i.e., moved with the clutch in the engaged condition, the latch is unlatched, and when the key barrel is operated, i.e., moved with the clutch in the disengaged condition, the latch does not unlatch.

### DETAILED DESCRIPTION OF THE DRAWINGS

The invention will now be described by way of example only, with reference to the accompanying drawings in which:

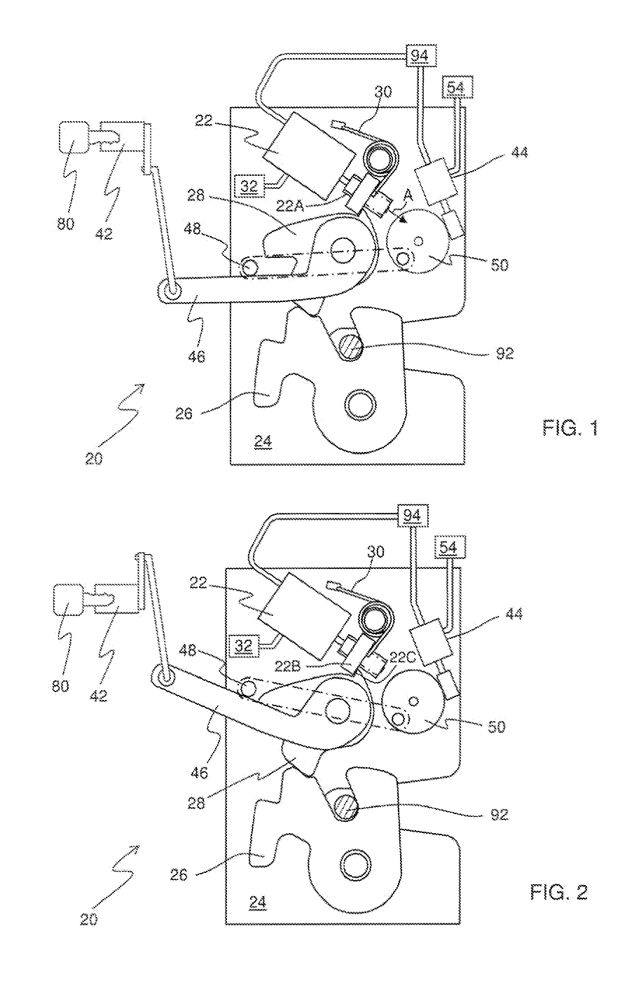

FIGS. 1 to 4 show a latch system according to the present invention in various positions;

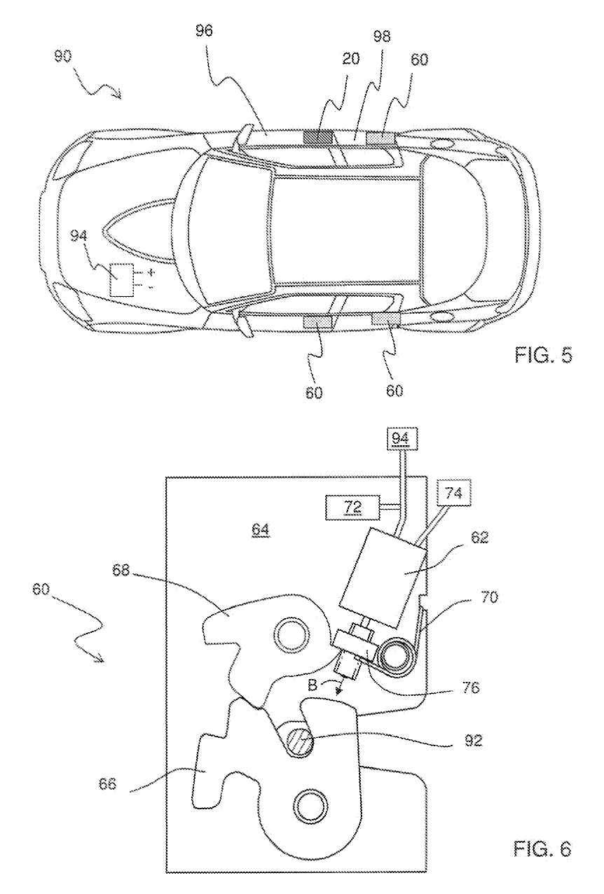

FIG. 5 shows a vehicle including the latch system of FIG. 1; and

FIGS. 6 to 8 show a second latch system in various positions, which latch system is also fitted to the vehicle shown in FIG. 5.

### DETAILED DESCRIPTION OF THE PREFERRED EMBODIMENT

With reference to FIGS. 1 to 4, there is shown a first latch 20 having a latch chassis 24 upon which is mounted a latch bolt in the form of a rotating claw 26. The rotating claw 26 releasably retains a striker 92. Typically, the first latch 20 may be mounted on a vehicle door, and the striker 92 may be mounted on the associated door aperture of the vehicle, typically on a B-post or a C-post of a vehicle. As shown in FIG. 1, the rotating claw 26 is in a closed position, being held in that position by a pawl 28. Rotation of the pawl 28 from the FIG. 1 position in a clockwise direction about a pivot 28C to the FIG. 4 position causes an abutment 28A to disengage from an abutment 26A, thereby allowing the rotating claw 26 to rotate in a clockwise direction about a pivot 26C and release the striker 92 from the mouth 26B of the rotating claw 26. FIG. 4 shows the moment at which the abutment 28A has been disengaged from the abutment 26A but just prior to the moment at which striker 92 will move to the right when viewing FIG. 4 relative to the latch chassis 24, thereby causing the rotating claw 26 to rotate clockwise about the pivot 26C to an open position (not shown for rotating claw 26, but see open position of rotating claw 66 as shown in FIG. 8).

The first latch 20 can be unlatched in one of two ways, firstly an unlatching actuator 22 can be operated to release the latch 20, and secondly, under certain circumstances, the rotation of a key 80 will cause the latch 20 to release.

In more detail, the unlatching actuator 22 is an electric actuator (in this case an electric motor) and is mounted on the latch chassis 24 and is powered via an electrical energy storage device in the form of battery 94. When unlatching is required, power is fed from the battery 94 to power the unlatching actuator 22, which causes screw thread 22A to rotate. A nut 22B is rotationally fast with the latch chassis 24 and hence is caused to translate in the direction of an arrow A, causing an abutment 22C of the nut 22B to engage and move the abutment 28B of the pawl 28. This in turn causes the pawl 28 to rotate clockwise about a pivot 28C, thereby disengaging the abutment 28A from the abutment 26A and hence releasing the latch 20.

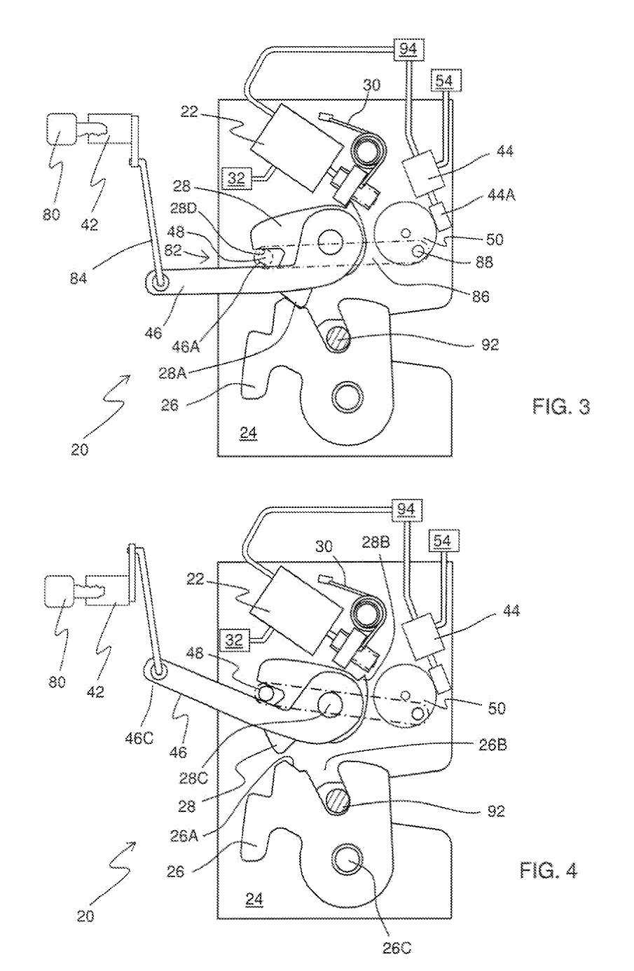

Alternatively, the latch 20 can be released by operating the key 80 as follows. As shown in FIG. 3, a clutch 82 is in an engaged position. The clutch 82 consists of a pin 48, an abutment 46A of a lever 46 and an abutment 28D of the pawl 28. As shown in FIG. 3, the pin 48 is positioned between the abutment 28D and the abutment 46A. The key barrel 42 is connected via a link 84 to an end of the lever 46. Manual rotation of the key 80 and hence rotation of the key barrel 42 from the position shown in FIG. 3 to the position shown in FIG. 4 causes the pin 48 to move generally upwardly, which in turn causes the end of the lever 46 to move generally upwardly as it rotates about the pivot 28C from the position shown in FIG. 3 to the position shown in FIG. 4. This in turn moves the abutment 46A generally upwardly, which causes the pin 48 to bear against the abutment 28D, which causes the pawl 28 to rotate in a clockwise direction, thereby disengaging the abutment 28A from the abutment 26A and releasing the latch 20.

However, the clutch 82 also has a disengaged position. Thus, as shown in FIG. 1, the pin 48 has been displaced to the left when comparing FIG. 1 with FIG. 3. The pin 48 is mounted on a link 86, which is pivotally mounted on a pin 88 of a gear wheel 50. The gear wheel 50 is connected to a clutch actuator 44 via a pinion 44A. The clutch actuator 44 is an electric actuator, in this case an electric motor. The battery 94 is capable of powering the clutch actuator 44 under the control of the control system 54. Under certain circumstances (as will be further described below), the clutch actuator 44 is powered via the battery 94 such that the gear wheel 50 is rotated in a clockwise direction from the position shown in FIG. 3 to the position shown in FIG. 1, thereby disengaging the clutch. As will be appreciated, as shown in FIG. 1, the pin 48 is no longer positioned between the abutments 46A and 28D. Under other circumstances, the clutch actuator 44 is powered by the battery 94 so as to rotate the gear wheel in a counter-clockwise direction from the FIG. 1 position to the FIG. 3 position thereby engaging the clutch 82.

When the clutch is disengaged, as shown in FIGS. 1 and 2, rotation of the key barrel 42 via the key 80 causes the lever 46 to rotate in a clockwise direction about the pivot 28C. However, because the clutch 82 is disengaged while the pin 48 is caused to move generally upwardly from the FIG. 1 position to the FIG. 2 position, the abutment 28D on the pawl 28 is not caused to move, and hence, when the lever 46 reaches the FIG. 2 position from the FIG. 1 position, the latch 20 is not released because the abutment 28A is still in engagement with abutment 26A.

The system operates as follows. Under normal circumstances, i.e., when the electrical system of the vehicle is fully functioning, when it is required to open the door, the unlatching actuator 22 will be powered by the battery 94 to move the nut 22B in the direction of the arrow A and hence release the latch 20, as described above. Under these circumstances, the clutch 82 will be disengaged, i.e., in the position shown in FIG. 1. When it is required to lock the vehicle and leave it parked the components will be positioned as shown in FIG. 1. The latch 20 will be locked because a thief will not have access to the remote unlocking device (such as a hand held radio transmitting device described above in respect of the prior art). Furthermore, the thief will not have access to the key 80 and will therefore not be easily able to rotate the key barrel 42.

In the event that the thief endeavours to forcibly rotate the key barrel 42, by using a screw driver or the like to “force” the key barrel 42, as the key barrel 42 is rotated to the position shown in FIG. 2 by the screw driver or the like, the latch 20 still will not open.

However, when the vehicle is left for a long time without being used, there is a risk that the battery 94 may start to discharge. If the battery 94 becomes fully discharged, it will not be possible to power actuator 22 to release the latch 20. Thus, in one embodiment, a control system monitors or estimates the amount of energy in the battery 94. When the amount of energy in the battery 94 falls below a predetermined level, the clutch actuator 44 is powered via the battery 94, and the gear wheel 50 is rotated from the FIG. 1 position to the FIG. 3 position, thereby engaging the clutch 82. For the purposes of this example, it is then assumed that the vehicle is left until such time as the energy in the battery 94 is insufficient to power the unlatching actuator 22 to release the latch 20. Under these circumstances, inserting the key 80 into the key barrel 42 and rotating the key 80 from the FIG. 3 position to the FIG. 4 position will release the latch 20.

While when the clutch 82 is engaged, the vehicle is less secure, because forcing the key barrel 42 via a screw driver or the like will release the latch 20, it is anticipated that a vehicle having a latch 20 will rarely, if ever, have the latch 20 positioned as shown in FIG. 3. This is because the electrical system on modern vehicles is inherently very reliable. Only on rare occasions, when a vehicle has been left for possibly several months without being used, will the latch 20 be positioned as shown in FIG. 3. A regularly used vehicle, i.e., a vehicle used daily or weekly or monthly, may never have the latch 20 positioned as shown in FIG. 3, and hence may never be at risk of having the key barrel 42 forced resulting in opening of the latch 20. Such a vehicle will only ever have the clutch disengaged (as per FIG. 1) and hence forcing of the key barrel 42 will not unlatch the latch 20.

The battery 94 will typically be the main battery of the vehicle. For vehicles having an internal combustion engine, the battery 94 is the battery which will be used to start the internal combustion engine. Typically, for a car, the battery 94 will be a 12 volt lead acid battery. For larger vehicles such as trucks, the battery 94 might be a 24 volt battery. For pure electric vehicles, the battery 94 can be the battery which propels the vehicle. FIG. 5 shows a vehicle, in this case a car 90, which has an internal combustion engine and hence a 12 volt battery 94 in the engine compartment. It is this battery 94 that will primarily be used to start the engine, operate lights and other ancillary equipment and also to power the unlatching actuator 22 when opening of the door is required. The battery 94 also powers the clutch actuator 44 when the amount of energy stored in the battery 94 has fallen below a predetermined level (as described above).

However, in the event of a crash, the battery 94 may become damaged and/or the electrical connections from the battery 94 to the latch 20 may become damaged. Under these circumstances, power from the battery 94 will not be available to operate either unlatching actuator 22 or the clutch actuator 44. For this reason, a further (second) electrical energy storage device, in this example in the form of a battery 32, is provided. In one embodiment, the only purpose of the battery 32 is to power the unlatching actuator 22 a limited number of times (for example, once or twice or three times or four times) so as to be able to unlatch the latch 20 and open the door in the event of an accident. As such, the energy storage capacity of battery 32 is significantly less than the energy storage capacity of the battery 94. The battery 32 can therefore typically be placed within the door associated with the latch 20 (or alternatively immediately adjacent the door associated with latch 20, especially when the latch 20 is mounted on the door frame and a striker is mounted on the door). In the event of an accident which results in the battery 94 being unable to provide power to the unlatching actuator 22, in order to open the door, the unlatching actuator 22 can be powered by the battery 32.

In an alternate embodiment, the battery 32 could be used to power the unlatching actuator 22 and also the clutch actuator 44. Thus, following a crash, the battery 32 could power the clutch actuator 44 to engage the clutch 82, which would provide an alternative way of unlatching the latch 20, i.e., the latch 20 could alternatively be opened by operation of the key.

Under an alternative set of circumstances where the vehicle has been parked for a significant amount of time and the electrical energy stored in the battery 94 has fallen below a predetermined level, the battery 32 could be operated to engage the clutch 82 rather than using the power from the battery 94.

In one embodiment, operation of the key cylinder 42 may be the sole way of manually releasing the latch 20, i.e., there is no outside door handle to operate the latch 20 and there is no inside door handle to operate the latch 20. Under these circumstances, the only other way of unlatching the latch 20 is by powering the unlatching actuator 22. In an alternate embodiment, the key cylinder 42 may be the sole manner of releasing the latch 20 from the outside, i.e., the latch 20 may have no outside door handle, but the latch 20 may have an inside door handle manual, operation of which moves the pawl 28 from the FIG. 3 position to the FIG. 4 position.

FIG. 5 shows the latch 20 mounted on the front right hand door of vehicle 90. The key cylinder 42 will be mounted on the outside of the door, and the key 80 will be insertable into the key cylinder 42 by a person standing on the outside of the vehicle, as is well known.

FIGS. 6 to 8 show a second latch 60 having an unlatching actuator 62 powered by battery 94, a chassis 64, a latch bolt in the form of a rotating claw 66, a pawl 68 and a spring 70. A comparison between FIG. 6 and FIG. 1 shows that the second latch 60 does not include a clutch (equivalent to the clutch 82), nor does it include a clutch actuator (the equivalent of the clutch actuator 44). The second latch 60 is not associated with a key cylinder or key (the equivalent of the key cylinder 42 and the key 80).

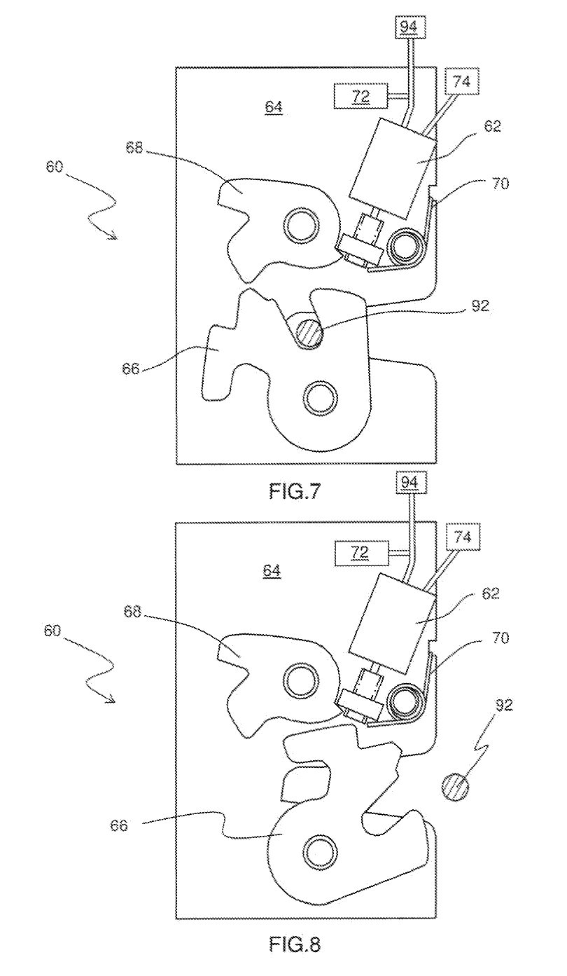

Unlatching of the second latch 60 occurs as follows. A control system 74 indicates an unlatching requirement, and a battery 94 supplies power to an unlatching actuator 62, which causes a nut 76 to move in the direction of an arrow B, resulting in a pawl 68 rotating in a clockwise direction and disengaging from a rotating claw 66 (as shown in FIG. 7). Once disengagement of the pawl 68 and the rotating claw 66 has occurred, the rotating claw 66 rotates to the position shown in FIG. 8, thereby releasing the striker 92. Once the door is open, the spring 70 returns the nut 76 to the FIG. 6 position.

The vehicle 90 has a latch 60 mounted on the front left hand door and on both rear doors. These three doors do not have any outside door handles which are able to manually release the latch 60, nor do they have any key barrels. As such, when mounted on the vehicle, the latches 60 have no way for manually unlatching the latch 60 from the outside of the vehicle.

In one embodiment, an inside door handle is provided for each latch 60, manual operation of which causes the pawl 68 to rotate clockwise and release the appropriate latch 60. In an alternative embodiment, the pawls 68 are not connected to any inside door handles and as such, in this embodiment, there is no way for manually releasing any of the latches 60 (be it from the inside or the outside).

In the event of an accident, an electrical energy storage device, in the form of a battery 72, is provided which can power the unlatching actuator 62 in the event that power from the battery 94 is unavailable.

The vehicle 90 incorporating the latch 20 and three latches 60 has more design freedom in terms of styling while retaining proper latch functionality. Thus, when the vehicle 90 incorporates an inside door handle associated with each latch which is operable to manually release the latch, then each door can be opened by operating the actuators 22 or 62, each door can be opened from the inside by manually operating the associated inside door handle in the event that the battery 94 is unable to power the actuators 22 or 62, additionally, in the event of a vehicle crash and power from the battery 94 being unavailable, the doors can also be opened from the inside by powering of the unlatching actuator via the battery 32 or 72 as appropriate, the handles on the outside of the vehicle operable to release the latch are not required, only one key cylinder need be provided on the outside of the vehicle, under normal circumstances (with the electrical system fully functioning) forcing the key cylinder 42 will not release the latch, and in the event of the battery 94 losing electrical charge, then it is still possible to open the door associated with the latch 20 by using a key.

As mentioned above, in one embodiment, the clutch 82 may never be engaged throughout the life of the vehicle, i.e., the gear wheel 50 may remain in the position shown in FIG. 1 throughout the life of the vehicle. In an alternative embodiment, it is possible to periodically engage and disengage the clutch 82 simply to ensure that the clutch actuator 44 and/or the gear wheel 50 do not seize. Thus, for example, the control system 54 may be configured to engage and disengage the clutch 82 when the associated door is shut and upon each occasion the engine is started. It is possible that the time taken to engage and disengage the clutch 82 will be relatively quick, for example it may take less than 10 seconds to engage and disengage the clutch 82, engagement and disengagement of the clutch 82 serving no purpose other than to ensure the clutch 82 has not seized.

As mentioned above, the unlatching actuator 22, the clutch actuator 44 and the unlatching actuator 62 are electric actuators, e.g., electric motors. The electrical energy storage devices 32, 72 and 94 can be any type of electrical energy storage device. With regard to electrical energy storage device 94, as described above, this may be a lead acid battery, though other types of battery are possible, especially when the vehicle is an electric vehicle. However, other types of electrical energy storage device can be employed, thus the components 94 and/or 32 and/or 72 could be capacitors or any other type of electrical energy storage device.

With regard to FIGS. 1 to 4, a key barrel 42 is operable (when the clutch is engaged) to release the latch. The key barrel 42 is operated by the key 80. In further embodiments, any type of removable coded manually operable device could be used in place of the key 80 and such an alternate device could be used with any type of associated coded movable element fixed to the vehicle. Thus, the term “key cylinder” should be understood to be any type of coded movable device fixed to the vehicle, and the term “key” should be understood as any type of removable coded security device which is manually operable to move the associated coded structure on the vehicle.

One aspect of the present invention is a latch system including a latch, a key barrel operably coupled via a clutch to the latch, the clutch having an engaged condition where operation of the key barrel unlatches the latch and the clutch having a disengaged condition where operation of the key barrel does not unlatch the latch.

While any type of latch can be used, the invention is particularly advantageously used in conjunction with the latch as described in international patent application number PCT/GB2006/000586. This application describes a latch assembly having a chassis, a latch bolt movably mounted on the chassis and having a closed position for retaining a striker and an open position for releasing the striker, a pawl having an engaged position at which the pawl is engaged with the latch bolt to hold the latch bolt in the closed position and a disengaged position at which the pawl is disengaged from the latch bolt thereby allowing the latch bolt to move to the open position, an eccentric arrangement defining an eccentric axis and a pawl axis remote from the eccentric axis, with the eccentric being rotatable about the eccentric axis and with the pawl being rotatable about the pawl axis. When the pawl moves from the engaged position to the disengaged position, the eccentric arrangement rotates in one of a clockwise and a counter-clockwise direction about the eccentric axis, and with the pawl in the engaged position, a force applied to the pawl by the latch bolt creates a turning moment on the eccentric arrangement about the eccentric axis in said one of a clockwise and a counter-clockwise direction and the eccentric arrangement is prevented from rotating in said one of a clockwise and a counter-clockwise direction by a moveable abutment.

PCT/GB2006/000586 shows various ways of moving the movable abutment including using a power release actuator or alternatively moving the abutment manually.

The key barrel of one aspect of the present invention may be operably coupled via a clutch to the movable abutment of the latch of international patent application number PCT/GB2006/000586 in order to manually move that movable abutment. The amount of energy required to move the movable abutment of PCT/GB2006/000586 is relatively small and hence by coupling the key cylinder of the present invention to the movable abutment of PCT/GB2006/000586 (via a clutch) it is relatively easy for a person to rotate the key and key barrel of the present invention to move the movable abutment of PCT/GB2006/000586 in order to release the latch shown in PCT/GB2006/000586.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. A latch system comprising:
a latch;
a key barrel operably coupled via a clutch to the latch, wherein the clutch has an engaged condition wherein operation of the key barrel unlatches the latch and a disengaged condition wherein operation of the key barrel does not unlatch the latch.

2. The latch system as defined in claim 1 including a key for manually operating the key barrel.

3. The latch system as defined in claim 1 including a first electric actuator, wherein operation of the first electric actuator causes the clutch to engage and/or disengage.

4. The latch system as defined in claim 1 including a second electric actuator for releasing the latch.

5. The latch system as defined in claim 1 wherein manual operation of the key barrel is the only way of manually unlatching the latch.

6. The latch system as defined in claim 3 including a first electrical energy storage device and a control system, wherein the control system monitors and/or estimates an amount of energy in the electrical energy storage device and when said amount of energy falls below a predetermined level, the first electric actuator is operated to engage the clutch.

7. The latch system as defined in claim 6 wherein the first electric actuator is powered by the first electrical energy storage device.

8. The latch system as defined in claim 6 including a second electrical energy storage device, wherein the first electric actuator is powered by the second electrical energy storage device.

9. The latch system as defined in claim 6 wherein the first electrical energy storage device is the main electrical energy storage device of the vehicle.

10. The latch system as defined in claim 9 wherein the vehicle includes a passenger door, the second electrical energy storage device being positioned in or immediately adjacent to the passenger door.

11. The latch system as defined in claim 1 wherein the key barrel is mounted on an outside of the vehicle, and manual operation of the key barrel is the only way of unlatching the latch from the outside of the vehicle.

12. The latch system as defined in claim 11 including a further latch system, wherein there is no way for manually unlatching the further latch system from the outside of the vehicle.
